(19) United States
(12) Patent Application Publication
(10) Pub. No.: US 2016/0345080 A1
(43) Pub. Date: Nov. 24, 2016

(54) METERING DEVICE AND METHOD FOR REMOTE METER READING

(71) Applicant: Naoki SAIKUSA, Tokyo (JP)

(72) Inventor: Naoki SAIKUSA, Tokyo (JP)

(21) Appl. No.: 15/111,990

(22) PCT Filed: Jan. 9, 2015
(86) PCT No.: PCT/JP2015/000075

§ 371 Date: Jul. 15, 2016

(30) Foreign Application Priority Data
Jan. 21, 2014 (JP) 2014-008695

(51) Int. Cl. H04Q 9/00; G01D 4/00; H04W 76/06

(52) U.S. Cl. CPC H04Q 9/00; H04W 76/06; G01D 4/002; H04Q 2209/40; H04Q 2209/60

(57) ABSTRACT

A metering device (1) is configured to connect to a base station (21) in a public radio communication network (2) and perform wireless communication with the base station (21). Further, the metering device (1) is configured to transmit, at each transmission opportunity for periodically transmitting meter reading data to a remote system (3), first meter reading data that is related to a measurement period and has never been transmitted previously toward the remote system (3) and second meter reading data that is related to a past measurement period and has already been transmitted toward the remote system (3) in a past transmission opportunity. This makes it possible, for example, to contribute to a reduction in time required for transmission and reception of data packets by a smart meter when sending meter reading data.

### TECHNICAL FIELD

The disclosure of the specification relates to a metering device for assisting remote meter reading and, more particularly, to transmission of meter reading data performed by a metering device having a wireless communication function.

### BACKGROUND ART

One of the major uses of smart meters is remote meter reading. Each smart meter has a function of collecting meter reading data that indicates, for example, watt-hour, gas usage, or water usage, and has a function of communicating bidirectionally with a remote system, thereby transmitting the meter reading data to the remote system. Further, for example, each smart meter receives instructions from the remote system and controls a switch or a valve in order to adjust watt-hour, gas usage, or water usage. The remote system connected to smart meters through a communication network is referred to as a “Meter Data Management System (MDMS)”. The MDMS communicates bidirectionally with smart meters, analyzes meter reading data sent from these smart meters, and controls these smart meters.

Many of commercialized smart meters have a wireless communication module for communicating with an MDMS. As an example, each smart meter is equipped with a short-range wireless module such as one conforming to ZigBee (IEEE 802.15.4, IEEE 802.15.4 g/e) and transmits meter reading data to the MDMS through multi-hop communication between smart meters. As another example, each smart meter includes a wide-area wireless communication module, thereby connecting with a base station in a public radio communication network and transmitting meter reading data to the MDMS through the public radio communication network. The wide-area wireless communication module included in the smart meter supports, for example, WiMAX (IEEE 802.16-2004), Mobile WiMAX (IEEE 802.16e-2005), Universal Mobile Telecommunications System (UMTS), Long Term Evolution (LTE), CDMA2000 (1×RTT, High Rate Packet Data (HRPD)), Global System for Mobile communications (GSM (Registered Trademark))/General packet radio service (GPRS), or the like.

### CITATION LIST

### Patent Literature

Patent Literature 1: Japanese Unexamined Patent Application Publication No. H11-313370
Patent Literature 2: Japanese Unexamined Patent Application Publication No. 2003-037874
Patent Literature 3: Japanese Unexamined Patent Application Publication No. 2011-254377
Patent Literature 4: Japanese Unexamined Patent Application Publication No. 2013-143672
Patent Literature 5: International Patent Publication No. WO2012/093433
Patent Literature 6: International Patent Publication No. WO2012/093434
Patent Literature 7: International Patent Publication No. WO2013/140743

### SUMMARY OF INVENTION

### Technical Problem

The present inventor has examined architecture in which a smart meter transmits meter reading data to an MDMS through a public radio communication network (e.g., WiMAX, Mobile WiMAX, UMTS, LTE, CDMA2000, or GSM/GPRS). This architecture may cause an increase in load on the public radio communication network when a number of smart meters perform communication at the same time or continuously. In general, public communication networks are used not only for communication performed by smart meters but also for communication performed by other types of mobile terminals (e.g., feature phones, smart phones, tablet computers, laptop computers, and so on). Therefore, communication performed by smart meters might prevent other types of mobile terminals from using public radio communication networks. This is because the processing capacity or the radio resources of a base station is finite, and accordingly there is an upper limit on the number of terminals that can be simultaneously connected to the base station. Therefore, when a smart meter uses a public radio communication network, it is desirable that the smart meter finishes communication in a short time.

In view of above, one object of embodiments disclosed in the specification is to provide a metering device, a method for remote meter reading, and a program contributing to a reduction in time required for transmission and reception of data packets by a smart meter when sending meter reading data. Other objects or problems and novel features will be made apparent from the following description in the specification and the accompanying drawings.

### Solution to Problem

In an aspect, a metering device includes a meter reading unit and a wireless communication unit. The meter reading unit is configured to collect meter reading data for each predetermined measurement period. The wireless communication unit is configured to connect to a base station in a public radio communication network, perform wireless communication with the base station, and transmit the meter reading data to a remote system. Further, the wireless communication unit is configured to transmit, at each transmission opportunity for periodically transmitting meter reading data to the remote system, first meter reading data that is related to a measurement period and has never been transmitted previously toward the remote system and second meter reading data that is related to a past measurement period and has already been transmitted toward the remote system in a past transmission opportunity.

In an aspect, a method for remote meter reading includes transmitting both of first meter reading data and second meter reading data at each transmission opportunity for periodically transmitting meter reading data from a smart meter to a remote system through a public radio communication network, the smart meter being configured to connect to a base station in the public radio communication network and perform wireless communication with the base station. The first meter reading data is related to a measurement period and has never been transmitted previously toward the remote system. The second meter reading data is related to a past measurement period and has already been transmitted toward the remote system in a past transmission opportunity.

In an aspect, a program includes a set of instructions (software code) which, when loaded into a computer, causes the computer to perform the above-described method for remote meter reading.

### Advantageous Effects of Invention

According to the above aspects, it is possible to provide a metering device, a method for remote meter reading, and a program contributing to a reduction in time required for transmission and reception of data packets by a smart meter when sending meter reading data.

### BRIEF DESCRIPTION OF DRAWINGS

FIG. 1 shows a configuration example of an Advanced Metering Infrastructure (AMI) system including smart meters according to a first embodiment;

FIG. 2 shows a configuration example of a smart meter according to the first embodiment;

FIG. 3 is a flowchart showing an example of a procedure for transmitting meter reading data by the smart meter according to the first embodiment;

FIG. 4 is a diagram for explaining determination of a timer value (T_IDLE) of an idle inactivity timer according to a second embodiment;

FIG. 5 shows state transitions of a mobile terminal in WiMAX; and

FIG. 6 shows state transitions of a mobile terminal in E-UTRAN (LTE).

### DESCRIPTION OF EMBODIMENTS

Specific embodiments are explained hereinafter in detail with reference to the drawings. The same or corresponding elements are denoted by the same reference symbols throughout the drawings, and their repeated explanations will be omitted for the sake of clarity.

Firstly, the definitions of the terms “idle state” and “connected state”, which are used both in the specification and in the claims, are explained. The idle state is a state in which a wireless connection between a mobile terminal and a base station has been released. Accordingly, the base station does not have information (context) about the mobile terminal in the idle state. The location of the mobile terminal in the idle state is tracked by a core network of a public radio communication network at paging-area level. The core network can reach the mobile terminal in the idle state by paging. Further, the mobile terminal in the idle state cannot perform unicast data transmission to and from the base station. Accordingly, the mobile terminal in the idle state needs to change its state to the connected state when performing unicast data transmission. Examples of the idle state include (1) an “Idle state” in WiMAX, Mobile WiMAX and WiMAX2 (IEEE 802.16 m), (2) an RRC idle state in Universal Terrestrial Radio Access Network (UTRAN), and (3) an RRC_IDLE state in Evolved Universal Terrestrial Radio Access Network (E-UTRAN).

In contrast to this, the connected state is a state in which the mobile terminal is connected to the base station. Accordingly, the base station holds information (context) about the mobile terminal in the connected state. The location of the mobile terminal in the connected state is tracked by the core network of the public radio communication network at cell level or base-station level. In general, the mobile terminal in the connected state can perform unicast data transmission to and from the base station. However, when the mobile terminal is in a CELL_PCH state or a URA_PCH state in the UTRAN, the context of the mobile terminal is held by the base station, but no dedicated channel is allocated to the mobile terminal either in uplink or downlink. Examples of the connected state include (1) a “Connected state” in WiMAX, Mobile WiMAX and WiMAX2, (2) an RRC connected state in UTRAN, and (3) an RRC_CONNECTED state in E-UTRAN. Note that the RRC connected state in UTRAN includes a CELL_DCH state, a CELL_FACH state, a CELL_PCH sate, and an URA_PCH state.

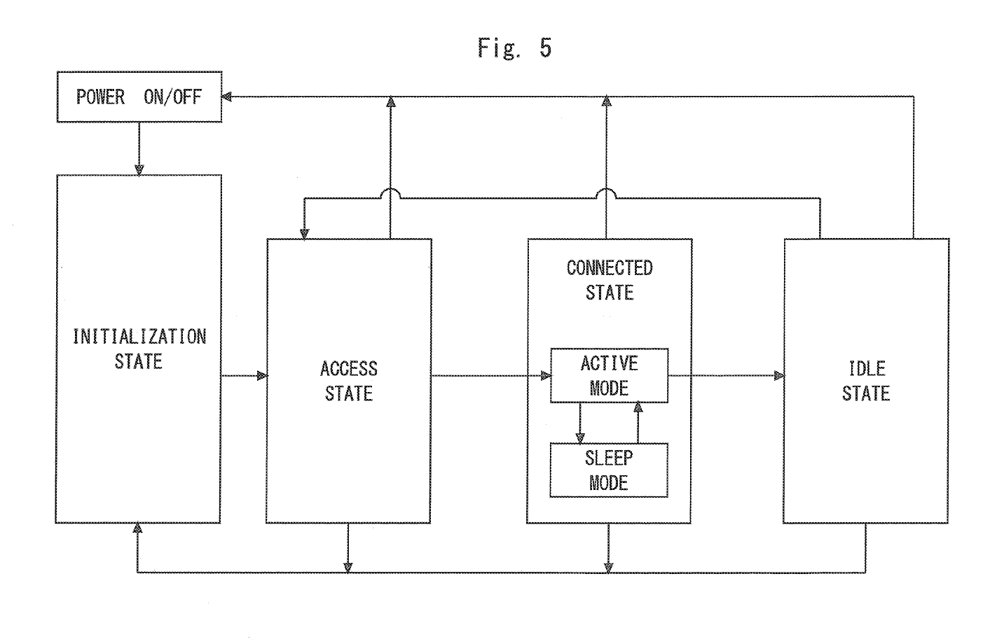

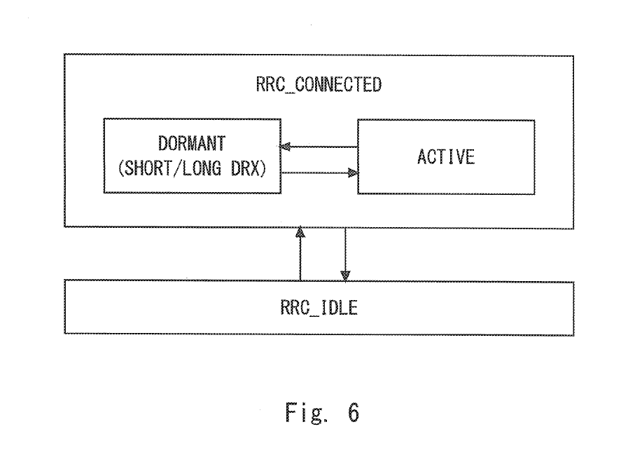

A mobile terminal in the connected state may perform discontinuous reception (DRX) in order to reduce the power consumption as in the case of mobile terminals in Mobile WiMAX, UTRAN, and E-UTRAN. In Mobile WiMAX, DRX in the connected state is defined as the sleep mode in the connected state. In E-UTRAN, DRX in the connected state is defined as the dormant mode (or the DRX mode) in the RRC_CONNECTED state. For a reference purpose, FIG. 5 shows state transitions of a mobile terminal in WiMAX and FIG. 6 shows state transitions of a mobile terminal in E-UTRAN/LTE.

In general, a mobile terminal transitions from the connected state to the idle state when inactivity duration during which no communication is performed in the connected state has reached a predetermined limit time. A timer that measures the inactivity duration to determine transition of the mobile terminal from the connected state to the idle state is referred to as, for example, an idle inactivity timer, an RRC inactivity timer, or a user inactivity timer. This timer is referred to as an idle inactivity timer in the specification. It should be noted that the idle inactivity timer should be differentiated from a timer (i.e., a DRX inactivity timer) that measures inactivity duration to determine transition of the mobile terminal from an active mode to a DRX mode (a sleep mode or a dormant mode) in the connected state. As described previously, the idle state differs from the DRX mode in the connected state in that while the idle state is a state in which a wireless connection (radio resources or an RRC connection) between the base station and the mobile terminal is released, the DRX mode is a state in which a wireless connection between the base station and the mobile terminal remains established.

### First Embodiment

FIG. 1 shows a configuration example of an Advanced Metering

Infrastructure (AMI) system including a smart meter 1 according to this embodiment. The smart meter 1 can connect to a base station 21 in a public radio communication network 2 and perform wireless communication with the base station 21. Then, the smart meter 1 communicates with a remotely located MDMS 3 through the public radio communication network 2. Specifically, the smart meter 1 is configured to transmit meter reading data to the MDMS 3 for remote meter reading. The meter reading data indicates, for example, watt-hour, gas usage, or water usage. The smart meter 1 may transmit meter reading data with time information for specifying its measurement period (e.g., the start time of the measurement period).

The smart meter 1 may perform other monitoring or controlling operations in cooperation with the MDMS 3. For example, the smart meter 1 may adjust the measurement period of meter reading data (e.g., 15-minute period, 30-minute period, or one-hour period) according to an instruction from the MDMS 3. Further, the smart meter 1 may transmit past meter reading data held in a memory of the smart meter 1 in response to a request from the MDMS 3. Further, the smart meter 1 may control a switch or a valve in order to adjust, for example, watt-hour, gas usage, or water usage in response to an instruction from the MDMS 3. Paging from the public radio communication network 2 may be used to allow the smart meter 1 to receive a request or an instruction from the MDMS 3.

The public radio communication network 2 in the specification is not a short-range wireless network such as one conforming to ZigBee (IEEE 802.15.4, IEEE 802.15.4g/e), but is instead a wide-area wireless infrastructure network covering. In other words, the public radio communication network 2 is a multiple-access mobile communication system. The multiple-access mobile communication system enables mobile terminals to perform radio communication substantially simultaneously by sharing radio resources including at least one of time, frequency, and transmission power among the mobile terminals. Typical examples of multiple-access technology include Time Division Multiple Access (TDMA), Frequency Division Multiple Access (FDMA), Code Division Multiple Access (CDMA), Orthogonal Frequency Division Multiple Access (OFDMA), and any combination thereof. The term “public radio communication network” in the specification means a multiple-access mobile communication system, unless otherwise specified.

The public radio communication network 2 is, for example, WiMAX, Mobile WiMAX, UMTS, LTE, a CDMA2000 system, or a GSM/GPRS system. The base station 21 performs bidirectional communication with mobile terminals including smart meters 1 located in its coverage (i.e., cell). A core network 22 is connected to a radio access network including the base station 21. The core network 22 has control plane functions including mobility and session management for mobile terminals (e.g., smart meters 1), and user plane functions including transfers of user data packets transmitted between mobile terminals (e.g., smart meters 1) and an external network (e.g., MDMS 3).

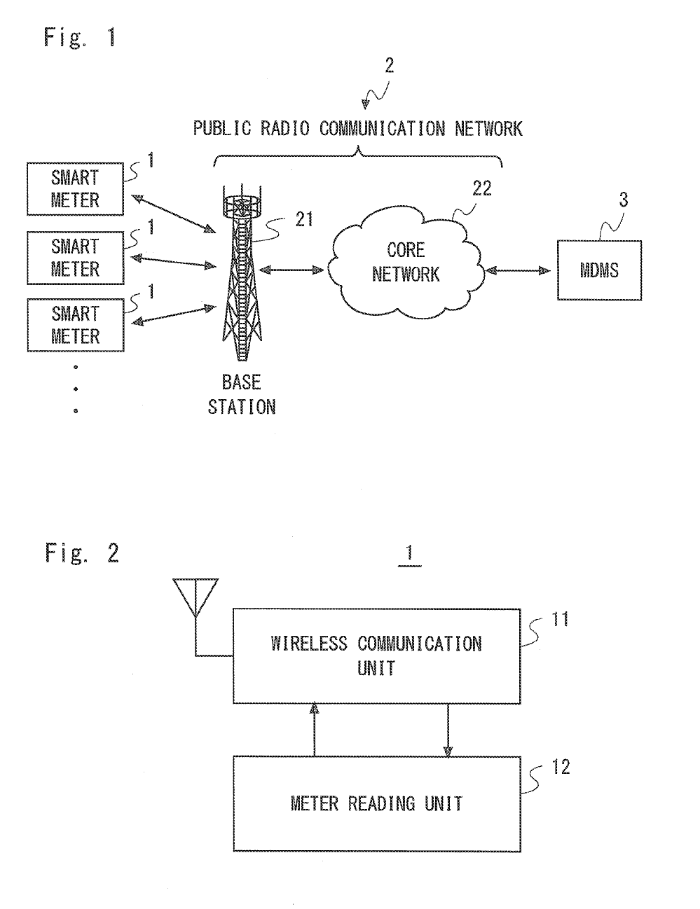

FIG. 2 is a block diagram showing a configuration example of a smart meter 1. The smart meter 1 includes a wireless communication unit 11 and a meter reading unit 12. The wireless communication unit 11 is configured to connect to the base station 21 in the public radio communication network 2 and perform wireless communication with the base station 21. The wireless communication unit 11 may also be referred to as a wireless communication module. The meter reading unit 12 collects meter reading data for each predetermined measurement period. The meter reading unit 12 may also perform monitoring or controlling operations (e.g., operation of a switch or a valve) in addition to the meter reading operation. The wireless communication unit 11 is used in combination with the meter reading unit 12 in order to support remote meter reading. That is, the wireless communication unit 11 transmits meter reading data collected by the meter reading unit 12 to the MDMS 3 through the public radio communication network 2.

In the following paragraphs, the procedure for transmitting meter reading data performed by the smart meter 1 according to this embodiment is explained in detail. The smart meter 1 (the meter reading unit 12) collects meter reading data for each predetermined measurement period (e.g., 15-minute period, 30-minute period, or one-hour period). The collected meter reading data may be recorded in a memory (not shown) included in the meter reading unit 12, recorded in a memory (not shown) included in the wireless communication unit 11, or recorded in a memory (now shown) included in the main body of the smart meter 1. The smart meter 1 (i.e., wireless communication unit 11) periodically transmits measurement data to the public radio communication network 2 (e.g., every five minutes, every 15 minutes, every 30 minutes, or every hour). The interval for periodic transmission of meter reading data to the MDMS 3 may be equal to or longer than the measurement interval (or measurement period) of the meter reading data.

The smart meter 1 (i.e., wireless communication unit 11) is adapted to transmit, at each transmission opportunity for periodically transmitting meter reading data to the MDMS 3, first meter reading data that is related to a measurement period and has never been transmitted previously toward the MDMS 3 and second meter reading data that is related to a past measurement period and has already been transmitted toward the MDMS 3 in a past transmission opportunity. Note that, the already-transmitted second meter reading data means meter reading data that the wireless communication unit 11 has completed the transmission to the MDMS 3. In other words, the second meter reading data may include not only meter reading data that has actually arrived at the MDMS 3 but also meter reading data that has not arrived at the MDMS 3 due to some reason. The smart meter 1 may transmit three or more meter reading data segments at each transmission opportunity. For example, the smart meter 1 may transmit, at each transmission opportunity, two already-transmitted meter reading data segments related to past measurement periods and one not-yet-transmitted meter reading data segment related to the latest measurement period subsequent to the past measurement periods. As an example, in a case where the measurement period (or measurement cycle) of meter reading data by the smart meter 1 is 30 minutes and the meter reading data is transmitted at intervals of 30 minutes, the smart meter 1 may transmit, at every transmission opportunity, two already-transmitted meter reading data segments related to past measurement periods and one not-yet-transmitted meter reading data segment related to the latest measurement period (i.e., three meter reading data segments related to the measurement periods equal to one hour and 30 minutes in total).

In this way, the smart meter 1 can omit end-to-end retransmission between the smart meter 1 and the MDMS 3 (e.g., TCP retransmission) at each transmission opportunity. This is because past meter reading data that has not arrived at the MDMS 3 in a past transmission opportunity will be transmitted again together with new meter reading data in a future transmission opportunity that periodically occurs. Therefore, the smart meter 1 according to this embodiment can increase the arrival probability of meter reading data by repeatedly transmitting the same meter reading data in a plurality of sporadic and periodic transmission opportunities without performing retransmission in each of the transmission opportunities.

Here, for a comparison purpose, assume a case where retransmission is used between the smart meter and the MDMS. In this case, the end-to-end retransmission between the smart meter and the MDMS requires the MDMS to send an acknowledge response to the smart meter (i.e., requires Ack transmission) when the transmission has succeeded. Further, when the transmission has ended in failure, the end-to-end retransmission requires the smart meter to perform retransmission to the MDMS. Therefore, the smart meter has to remain in the connected state at least during the time period necessary for performing the retransmission procedure in order to receive one or more downlink data packets containing the acknowledge response from the base station and transmit one or more uplink data packets containing the retransmitted meter reading data to the base station.

In contrast to this, the smart meter 1 according to this embodiment can omit the end-to-end retransmission between the smart meter 1 and the MDMS 3. Therefore, after transmitting one or more uplink data packets containing first and second meter reading data, the smart meter 1 (i.e. wireless communication unit 11) does not have to perform either subsequent transmission of uplink data packets or reception of downlink-data packets in each transmission opportunity. Consequently, the smart meter 1 can contribute to a reduction in time required for transmission and reception of data packets for sending meter reading data at each transmission opportunity. As a result, the smart meter 1 (i.e., wireless communication unit 11) is allowed to change its state from the connected state to the idle state immediately after transmitting the uplink data packet(s) containing the first and second meter reading data.

Note that, when there is no need to receive paging from the public radio communication network 2, the smart meter 1 may change its state to a non-connected state (e.g., power-off state or detach state) other than the idle state. In the power-off state (or the detach state), the information about the smart meter 1 (i.e., wireless communication unit 11) is released not only in the base station 21 but also in the core network 22 and the mobility management of the smart meter 1 is not performed. The power-off state (or the detach state) might be more effective than the idle state in view of the reduction in power consumption. However, the transition from the power-off state (or the detach state) to the connected state requires transmission of a larger number of signaling messages and hence takes a longer time than that required for the transition from the idle state to the connected state. Therefore, whether the wireless communication unit 11 of the smart meter 1 remains in the idle state or in the power-off state (or the detach state) when the smart meter 1 is not in a transmission opportunity may be determined as desired based on the necessity of paging, the load on the core network 22, and so on.

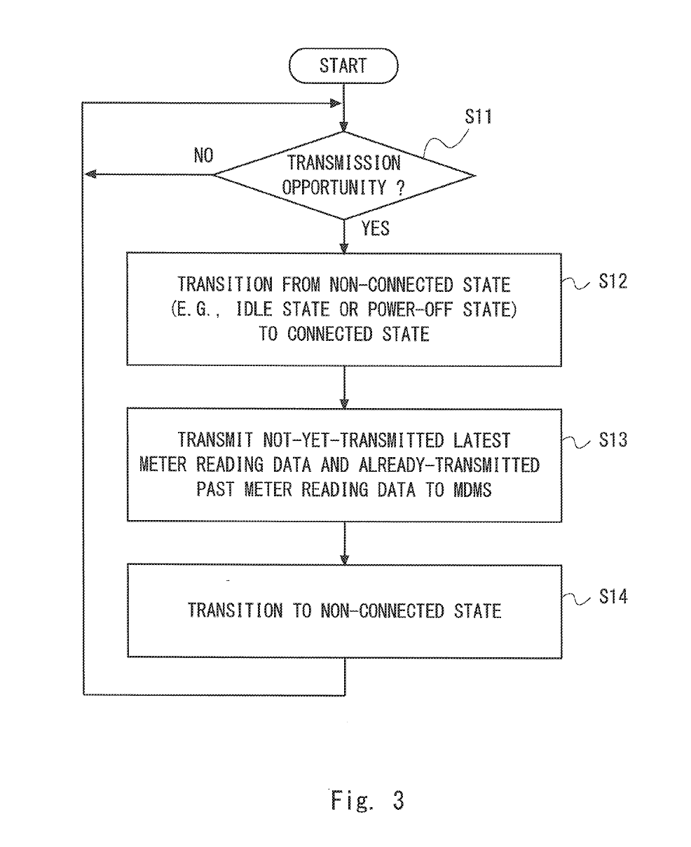

FIG. 3 is a flowchart showing a specific example of a procedure for transmitting meter reading data performed by the smart meter 1 (i.e., wireless communication unit 11). In a step S11, the smart meter 1 (i.e., wireless communication unit 11) determines whether or not the time for a periodic transmission opportunity has come. When the time for a transmission opportunity has come (Yes at step S11), the smart meter 1 (i.e., wireless communication unit 11) accesses a memory in the smart meter 1 and generates one or more data packets containing not-yet-transmitted meter reading data (i.e., first meter reading data) related to the latest measurement period and meter reading data (i.e., second meter reading data) that is related to a past measurement period and has already been transmitted toward the MDMS 3. The plurality of meter reading data including the first and second meter reading data has been collected by the meter reading unit 12 for each predetermined measurement period and stored in the memory in the smart meter 1. Then, the smart meter 1 (i.e., wireless communication unit 11) transitions from the non-connected state (e.g., idle state or power-off state) to the connected state upon generating the one or more data packets containing the first and second meter reading data (step S12). In a step S13, the smart meter 1 (i.e., wireless communication unit 11) transmits the one or more data packets containing the first and second meter reading data toward the MDMS 3.

The smart meter 1 (i.e., wireless communication unit 11) may preferably transmit the first and second meter reading data by using a protocol that does not include a retransmission procedure (e.g., UDP) as a transport layer protocol of the Open Systems Interconnection (OSI) reference model. If the smart meter 1 (i.e., wireless communication unit 11) uses a transport layer protocol that includes a retransmission procedure (e.g., TCP), the smart meter 1 and the MDMS 3 has to perform a handshake (e.g., TCP three-way handshake) in order to establish a connection therebetween before transmitting data packets and hence have to exchange control packets for the handshake. Further, if the smart meter 1 (i.e., wireless communication unit 11) uses a transport layer protocol that includes a retransmission procedure, the smart meter 1 has to receive an acknowledge response (ACK) after the transmission of a data packet and, when the acknowledge response (ACK) cannot be received, has to perform retransmission.

In contrast to this, by using a protocol that does not include a retransmission procedure (e.g., UDP), the smart meter 1 can immediately start transmitting the one or more data packets containing the first and second meter reading data and does not have to either receive the acknowledge response (ACK) or retransmit the data packet(s). Therefore, by using a protocol that does not include a retransmission procedure (e.g., UDP), the smart meter 1 can reduce the time necessary for the transmission and the reception of data packets for sending meter reading data in each transmission opportunity.

The explanation is continued by referring to FIG. 3 again. In a step S14, the smart meter 1 (i.e., wireless communication unit 11) transitions from the connected state to the non-connected state (e.g., idle state or power-off state) when the inactivity duration in the connected state has reached a predetermined limit time (T_IDLE), i.e., when the idle inactivity timer has expired. The idle inactivity timer may be managed by one or both of the smart meter 1 (i.e., wireless communication unit 11) and the base station 21. When the idle inactivity timer managed by the smart meter 1 has expired, the smart meter 1 may make a request to the base station 21 about the transition to the non-connected state. Alternatively, when the idle inactivity timer managed by the base station 21 has expired, the base station 21 may request the smart meter 1 to transition to the non-connected state.

In order to reduce the time during which the smart meter 1 remains in the connected state, the idle inactivity timer value (T_IDLE) is preferably set to as small a value as possible. That is, by setting a small timer value (T_IDLE) in the idle inactivity timer in addition to transmitting the first and second meter reading data at each transmission opportunity and using a protocol that does not include a retransmission procedure (e.g., UDP), the time during which the smart meter 1 remains in the connected state can be reduced even further. However, an excessive reduction in the idle inactivity timer value (T_IDLE) may interfere with the control procedure related to the public radio communication network 2 that should be performed by the mobile terminal in the connected state. Suitable setting for the idle inactivity timer value (T_IDLE) is explained in the below-shown second embodiment.

Note that, as explained in the below-shown second embodiment, the adjustment of the inactivity timer value (T_IDLE) for the smart meter 1 contributes to reducing the time during which the smart meter 1 remains in the connected state to transmit meter reading data. However, when the period in which the smart meter 1 transmits and/or receives data packets in order to send meter reading data to the MDMS 3 is long or when the transmission/reception of data packets performed by the smart meter 1 intermittently occur, the time during which the smart meter 1 remains in the active mode could become longer. Therefore, it may be desirable that the smart meter 1 be able to complete the transmission of meter reading data in the active mode in a short time. The method for transmitting meter reading data explained above in this embodiment, i.e., the transmission method including transmitting first and second meter reading data at each transmission opportunity contributes to facilitating omission of the retransmission procedure and thereby allowing completion of meter reading data transmission in the active mode in a short time.

### Second Embodiment

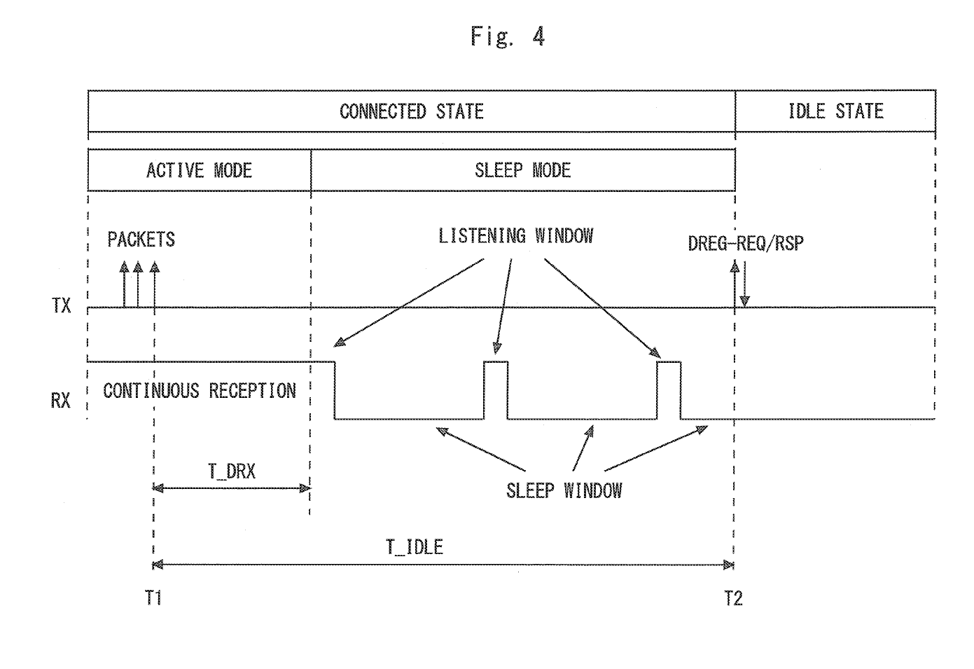

In this embodiment, how to determine a timer value (T_IDLE) for the idle inactivity timer that is used to allow the smart meter 1 to transition from the connected state to the idle state is explained. FIG. 4 shows the definition of T_IDLE in this embodiment. Note that FIG. 4 shows the definition of T_IDLE conforming to the terms for Mobile WiMAX. For the terms of LTE, the terms shown in FIG. 4 can be changed as shown below:
Connected state in FIG. 4 - - - >RRC_CONNECTED state in LTE;
Idle state in FIG. 4 - - - >RRC_IDLE state in LTE;
Active mode in FIG. 4 - - - >Active mode in LTE;
Sleep mode in FIG. 4 - - - >Dormant mode in LTE;
Listening window in FIG. 4 - - - >ON duration in LTE; and
Sleep window in FIG. 4 - - - >OFF duration in LTE.

The idle inactivity timer (T_IDLE) is reset (or restarted) every time the smart meter 1 (i.e., wireless communication unit 11) transmits or receives a packet. In the example shown in FIG. 4, when the T_IDLE has elapsed (T2) since the smart meter 1 transmitted the last packet (T1), the smart meter 1 transitions from the connected state to the idle state.

Further, FIG. 4 also shows the DRX inactivity timer (T_DRX) that is used to allow the smart meter 1 to transition to the DRX state (a sleep mode) in the connected state. Similarly to the idle inactivity timer (T_IDLE), the DRX inactivity timer (T_DRX) is reset (or restarted) every time the smart meter 1 (i.e., wireless communication unit 11) transmits or receives a packet. The T_DRX is shorter than the T_IDLE. In the case of T_DRX in LTE, the T_DRX is, for example, about 100 ms.

As described in the first embodiment, the shorter the T_IDLE is, the more immediately the smart meter 1 can transition from the connected state to the idle state. However, an excessively short T_IDLE may interfere with, for example, the control procedure performed in the connected state and the like. As an example, assume a case where the core network 22 performs some control in response to an uplink control packet transmitted from the smart meter 1 in the connected state. In this case, excessively short T_IDLE may cause the smart meter 1 to transition to the idle state before a control message transmitted from the core network 22 arrives at the smart meter 1. For example, in Mobile WiMAX, a mobile terminal in the connected state takes part in control procedures including a Reauthentication procedure, a Handover procedure, a Location Update procedure, a Re-anchoring procedure, an IP Re-anchoring procedure, and a DHCP Session Renewal procedure. Further, in LTE, a mobile terminal has to transition to the RRC_CONNECTED state in order to communicate with the core network and the mobile terminal performs substantially all the control procedures with the core network when the mobile terminal is in the RRC_CONNECTED state. For example, in LTE, a mobile terminal in the connected state takes part in control procedures including an Attach procedure, a Service Request procedure, a Tracking Area Update procedure, a GUTI Reallocation procedure, an ME Identity Check procedure, a QoS Modification procedure, and a Bearer Modification procedure.

Accordingly, the idle inactivity timer value (T_IDLE) is preferably set to a value that is longer than the time (T_SIGNAL) necessary to complete the control procedure performed between the smart meter 1 (i.e., wireless communication unit 11) and the public radio communication network 2 while the smart meter 1 (i.e., wireless communication unit 11) remains in the connected state. However, an excessively long T_IDLE should be avoided because it could wastefully consume radio resources. Therefore, the T_IDLE is preferably set to a value that is longer than the time (T_SIGNAL) necessary for completing the control procedure and is smaller than twice the time necessary for completing the control procedure (i.e., 2*T_SIGNAL). Based on tests for Mobile WiMAX, the present inventor has acquired knowledge that the time (T_SIGNAL) necessary for completing the control procedure is about one second. Accordingly, the T_IDLE may be substantially no shorter than one second and no longer than two seconds. Note that the upper limit value for the T_IDLE may be set with an enough margin to cope with various delays in the public radio communication network 2. Accordingly, the T_IDLE may be substantially no shorter than one second and no longer than five seconds.

Alternatively, the upper limit for the idle inactivity timer value (T_IDLE) may be determined in view of other aspects. Specifically, it may be determined based on the maximum number of terminals that can connect to the base station 21 and complete desired communication within the unit time. For example, a target may be set in such a manner that transactions five times as large as those performed by the maximum number of terminals that can simultaneously connect to the base station 21 can be completed within one minute. In this case, the time that can be allowed for one transaction performed by one terminal is 12 seconds. Further, this time period of 12 seconds includes the time that the mobile terminal takes to transition from the non-connected state to the connected state and the time for data transmission. Accordingly, the upper limit for the T_IDLE should be shorter than 12 seconds and may be preferably set to about 10 seconds.

### Other Embodiments

The idle inactivity timer value (T_IDLE) for the smart meter 1 explained in the first and second embodiments may be adjusted in a manner similar to those disclosed in Patent Literatures 1 to 7. Patent Literatures 1 to 7 disclose adjustments of the idle inactivity timer value (T_IDLE) based on various factors. In Patent Literatures 1 to 7, the idle inactivity timer value (T_IDLE) is adjusted based on, for example, the type of a mobile terminal, a moving speed, the frequency of movements, the frequency of communication, a communication period, a communication interval, the amount of data per communication, a traffic pattern, a port number contained in a Transmission Control Protocol (TCP) header or a User Datagram Protocol (UDP) header, an application program executed by a mobile terminal, the remaining amount of a battery, the location of a mobile terminal, a time zone, the type of a wireless network to which a mobile terminal is connected, the load on a base station, or the load on a core network. The smart meter 1 or the base station 21 may determine the idle inactivity timer value (T_IDLE) for the smart meter 1 based on these factors.

Further or alternatively, the idle inactivity timer value (T_IDLE) for the smart meter 1 may be determined at the time of a contract for the use of a service (e.g., electric service, water service, or gas service) provided by a communication service provider, i.e., a service for which remote meter reading is performed by using the smart meter 1.

Further or alternatively, the idle inactivity timer value (T_IDLE) for the smart meter 1 may be adjusted when the service (e.g., remote meter reading service) in which the smart meter 1 is used is changed. For example, the smart meter 1 may receive a timer change message indicating a change in the idle inactivity timer value (T_IDLE) from the base station 21, a control node in the core network 22, or the MDMS 3, and change the timer value (T_IDLE) in response to the timer change message. For example, the smart meter 1 may be used for both of a remote watt-hour meter reading service and a remote meter reading service for other usage (e.g., gas usage or water usage). In such a case, the smart meter 1 may change the idle inactivity timer value (T_IDLE) that is used to transmit watt-hour meter reading data from the timer value that is used to transmit meter reading data indicating other usage (e.g., gas usage or water usage). In other words, the smart meter 1 may support remote meter reading for a plurality of services to be provided (e.g., electric service, water service, and gas service). Further, the idle inactivity timer value (T_IDLE) for the smart meter 1 may be changed for each of the plurality of services to be provided. In this way, suitable timer values (T_IDLEs) can be used according to the type of service in which the smart meter 1 is used.

Further or alternatively, the idle inactivity timer value (T_IDLE) for the smart meter 1 may be changed according to the packet type of transmission data packets or reception data packets of the smart meter 1. For example, the smart meter 1 or the base station 21 may detect the packet type of transmission data packets or reception data packets of the smart meter 1 and use the timer value (T_IDLE) corresponding to the detected packet type. For example, the smart meter 1 or the base station 21 may monitor a protocol number field in an IP (Internet Protocol) header of an IP packet transmitted or received by the smart meter 1 and use a different timer value (T_IDLE) according to the protocol number field value. For example, the timer value (T_IDLE) may be changed depending on: (a) whether the used protocol is a connection-type protocol such as TCP or a connectionless-type protocol such as UDP; or (b) whether the used protocol is a protocol with retransmission such as TCP or a protocol without retransmission such as UDP. For example, when the protocol number field indicates UDP, the smart meter 1 or the base station 21 may use a shorter timer value (T_IDLE) than that is used when the protocol number field indicates TCP. In this way, it is possible to use a timer value (T_IDLE) suitable for an average communication time based on the characteristic of the communication protocol used by the smart meter 1.

The procedures for transmitting meter reading data performed by the smart meter 1 explained in the first and second embodiments may be implemented by causing a computer system including at least one processor to execute a program. Specifically, one or more programs containing a set of instructions for causing a computer system to perform the algorithm for transmitting meter reading data explained with reference to FIG. 3 and the like may be supplied to the computer system.

These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Further, the above-described embodiments are merely examples for the application of the technical ideas achieved by the present inventor. That is, needless to say, the technical ideas are not limited to the above-described embodiments and the above embodiments may be modified in various ways.

This application is based upon and claims the benefit of priority from Japanese patent application No. 2014-008695, filed on Jan. 21, 2014, the disclosure of which is incorporated herein in its entirety by reference.

### REFERENCE SIGNS LIST

1 SMART METER
2 PUBLIC RADIO COMMUNICATION NETWORK
3 METER DATA MANAGEMENT SYSTEM (MDMS)
11 WIRELESS COMMUNICATION UNIT
12 METER READING UNIT
21 BASE STATION
22 CORE NETWORK

1. A metering device comprises:
at least one memory that stores a set of instructions; and
at least one hardware processor configured to execute the set of instructions to:
correct meter reading data for each predetermined measurement period; and
transmit the meter reading data to a remote system through a public radio communication network including a base station, wherein
the set of instructions causes the at least one hardware processor to transmit, at each transmission opportunity for periodically transmitting meter reading data to the remote system, first meter reading data that is related to a first measurement period and has never been transmitted previously toward the remote system and second meter reading data that is related to a second measurement period and has already been transmitted toward the remote system in a past transmission opportunity.

2. The metering device according to claim 1, wherein the set of instructions causes the at least one hardware processor to:
transmit the first and second meter reading data in a connected state at each transmission opportunity; and
when a period during which no data packet is transmitted or received in the connected state exceeds a predetermined length of time, make the metering device transition from the connected state to a non-connected state in which a wireless connection with the base station is released.

3. The metering device according to claim 2, wherein the predetermined length of time is longer than a processing time necessary to complete a control procedure performed between the metering device and the public radio communication network while the metering device is in the connected state, and is shorter than twice the processing time.

4. The metering device according to claim 2, wherein the predetermined length of time is longer than a processing time necessary to complete a control procedure performed between the metering device and the public radio communication network while the metering device is in the connected state, and is shorter than five seconds.

5. The metering device according to claim 2, wherein the predetermined length of time is no shorter than one second and no longer than five seconds.

6. The metering device according to claim 5, wherein the predetermined length of time is no shorter than one second and no longer than two seconds.

7. The metering device according to claim 2, wherein the predetermined length of time is determined for each contract for use of a service for which remote meter reading is performed.

8. The metering device according to claim 2, wherein
the metering device is configured to support remote meter reading for a plurality of services, and
the set of instructions causes the at least one hardware processor to change the predetermined length of time depending on which of the plurality of services the first and second meter reading data are related to.

9. The metering device according to claim 2, wherein the set of instructions causes the at least one hardware processor to change the predetermined length of time according to a packet type of transmission data or reception data of the metering device.

10. The metering device according to claim 9, wherein
the packet type is related to a transport layer protocol of the Open Systems Interconnection (OSI) reference model applied to the transmission data or the reception data, and
the set of instructions causes the at least one hardware processor to change the predetermined length of time depending on whether the transport layer protocol is a connection-type protocol or a connectionless-type protocol.

11. The metering device according to claim 10, wherein the connection-type protocol includes Transmission Control Protocol (TCP) and the connectionless-type protocol includes User Datagram Protocol (UDP).

12. The metering device according to claim 2, wherein, at each transmission opportunity, the set of instructions causes the at least one hardware processor to make the metering device transition from the non-connected state to the connected state in response to generation of one or more data packets containing the first and second meter reading data.

13. The metering device according to claim 2, wherein
the connected state includes at least one of (a) a connected state in WiMAX, Mobile WiMAX, or WiMAX2, (b) an RRC_CONNECTED state in Evolved Universal Terrestrial Radio Access Network (E-UTRAN), and (c) an RRC connected state in Universal Terrestrial Radio Access Network (UTRAN), and
the non-connected state includes at least one of (a) an idle state in WiMAX, Mobile WiMAX, or WiMAX2, (b) an RRC_IDLE state in LTE, and (c) an RRC idle state in UTRAN.

14. The metering device according to claim 1, wherein the set of instructions causes the at least one hardware processor to transmit the first and second meter reading data by using a first protocol with no retransmission procedure as a transport layer protocol of the Open Systems Interconnection (OSI) reference model.

15. The metering device according to claim 14, wherein the first protocol is User Datagram Protocol (UDP).

16. The metering device according to claim 1, wherein the first and second meter reading data indicates watt-hour, gas usage, or water usage.

17. A method for remote meter reading comprising:
transmitting both of first meter reading data and second meter reading data at each transmission opportunity for periodically transmitting meter reading data from a smart meter to a remote system through a public radio communication network, wherein
the smart meter is configured to connect to a base station in the public radio communication network and perform wireless communication with the base station,
the first meter reading data is related to a first measurement period and has never been transmitted previously toward the remote system, and
the second meter reading data is related to a second act measurement period and has already been transmitted toward the remote system in a past transmission opportunity.

18. The method according to claim 17, wherein the transmitting comprises:
transmitting the first and second meter reading data in a connected state at each transmission opportunity; and
when a period during which no data packet is transmitted or received in the connected state exceeds a predetermined length of time, transitioning from the connected state to a non-connected state in which a wireless connection with the base station is released.

19. The method according to claim 18, wherein the predetermined length of time is longer than a processing time necessary to complete a control procedure performed between the smart meter and the public radio communication network while the smart meter is in the connected state, and is shorter than twice the processing time.

20. The method according to claim 18, wherein the predetermined length of time is longer than a processing time necessary to complete a control procedure performed between the smart meter and the public radio communication network while the smart meter is in the connected state, and is shorter than five seconds.

21. The method according to claim 18, wherein the predetermined length of time is no shorter than one second and no longer than five seconds.

22. The method according to claim 21, wherein the predetermined length of time is no shorter than one second and no longer than two seconds.

23. The method according to claim 18, wherein the predetermined length of time is determined for each contract for use of a service for which remote meter reading by using the smart meter is performed.

24. The method according to claim 18, wherein
the smart meter is configured to support remote meter reading related for a plurality of services, and
the method further comprises changing, by the smart meter, the predetermined length of time depending on which of the plurality of services the first and second meter reading data are related to.

25. The method according to claim 18, further comprising changing the predetermined length of time according to a packet type of transmission data or reception data of the smart meter.

26. The method according to claim 25, wherein
the packet type is related to a transport layer protocol of the Open Systems Interconnection (OSI) reference model applied to the transmission data or the reception data, and
the changing comprises changing the predetermined length of time depending on whether the transport layer protocol is a connection-type protocol or a connectionless-type protocol.

27. The method according to claim 26, wherein the connection-type protocol includes Transmission Control Protocol (TCP) and the connectionless-type protocol includes User Datagram Protocol (UDP).

28. The method according to claim 18, wherein the transmitting comprises, at each transmission opportunity, transitioning from the non-connected state to the connected state in response to generation of one or more data packets containing the first and second meter reading data.

29. The method according to claim 18, wherein
the connected state includes at least one of (a) a connected state in WiMAX, Mobile WiMAX, or WiMAX2, (b) an RRC_CONNECTED state in Evolved Universal Terrestrial Radio Access Network (E-UTRAN), and (c) an RRC connected state in Universal Terrestrial Radio Access Network (UTRAN), and
the non-connected state includes at least one of (a) an idle state in WiMAX, Mobile WiMAX, or WiMAX2, (b) an RRC_IDLE state in E-UTRAN, and (c) an RRC idle state in UTRAN.

30. The method according to claim 17, wherein the transmitting comprises transmitting the first and second meter reading data by using a first protocol without using retransmission as a transport layer protocol of the Open Systems Interconnection (OSI) reference model.

31. The method according to claim 30, wherein the first protocol is User Datagram Protocol (UDP).

32. A non-transitory computer readable medium storing a program for causing a computer to perform a method for remote meter reading, wherein the method comprises
transmitting both of first meter reading data and second meter reading data at each transmission opportunity for periodically transmitting meter reading data from a smart meter to a remote system through a public radio communication network, wherein
the smart meter is configured to connect to a base station in the public radio communication network and perform wireless communication with the base station,
the first meter reading data is related to a first measurement period and has never been transmitted previously toward the remote system, and
the second meter reading data is related to a second measurement period and has already been transmitted toward the remote system in a past transmission opportunity.

33. A communication device comprising:
at least one memory that stores a set of instructions; and
at least one hardware processor configured to execute the set of instructions to:
transmit, at each transmission opportunity for periodically transmitting meter reading data to a remote system through a public radio communication network including a base station, first meter reading data that is related to a first measurement period and has never been transmitted previously toward the remote system and second meter reading data that is related to a second measurement period and has already been transmitted toward the remote system in a past transmission opportunity.
